(19) United States
(12) Patent Application Publication
(10) Pub. No.: US 2026/0087109 A1
(43) Pub. Date: Mar. 26, 2026

(54) ROLE-BASED TOOL CONTROLLER FOR AI COPILOT

(71) Applicant: SAP SE, Walldorf (DE)

(72) Inventor: Srinivasa Byaiah Ramachandra REDDY, Bangalore (IN)

(21) Appl. No.: 18/898,222

(22) Filed: Sep. 26, 2024

(51) Int. Cl. G06F 21/31

(52) U.S. Cl. CPC G06F 21/31

(57) ABSTRACT

Disclosed herein are system, method, and computer program product embodiments for performing a tool based on a user role. An embodiment operates by storing a conversation log, wherein the conversation log comprises a user input to an Artificial Intelligence (AI) copilot and an AI output to the user, wherein the AI copilot runs on an AI service system. The embodiment then determines the user role of the user. The embodiment then analyzes the conversation log to identify a requested tool requested by the user. The embodiment then determines a required role required to perform the requested tool. The embodiment then compares the required role and the user role. The embodiment then determines, based on the comparison, that the user has an authority to perform the requested tool.

### BACKGROUND

Recently, the importance of controlling user access to cloud product portfolios using an Artificial Intelligence (AI) copilot has been increasing. The AI copilot works seamlessly across the entire cloud product portfolio. The developers of AI service systems publish tools they have been developed for the AI copilot, and the ecosystem of AI service systems develops as users access the published tools and provide feedback through conversations with the AI copilot.

One of the technical issues that arise when users access tools using AI copilots is the issue of access control. The products in the cloud product portfolio use a large number of tools, and access rights to these tools may be managed in a complex manner. If a user who does not have access rights to the tool is prompted to use the tool by the AI copilot, the user will not be able to execute the tool and an error will occur on the system.

### BRIEF DESCRIPTION OF THE DRAWINGS

The accompanying drawings are incorporated herein and form a part of the specification.

FIG. 1 is a block diagram of an AI service system, according to some embodiments.

FIG. 2 is a block diagram of an AI service system where a tool has a description without a required role, according to some embodiments.

FIG. 3 is a block diagram of an AI service system where the AI service system updates the mapping, according to some embodiments.

FIG. 4 is a flowchart illustrating a process for performing a tool based on a user role, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for performing a tool based on a user role.

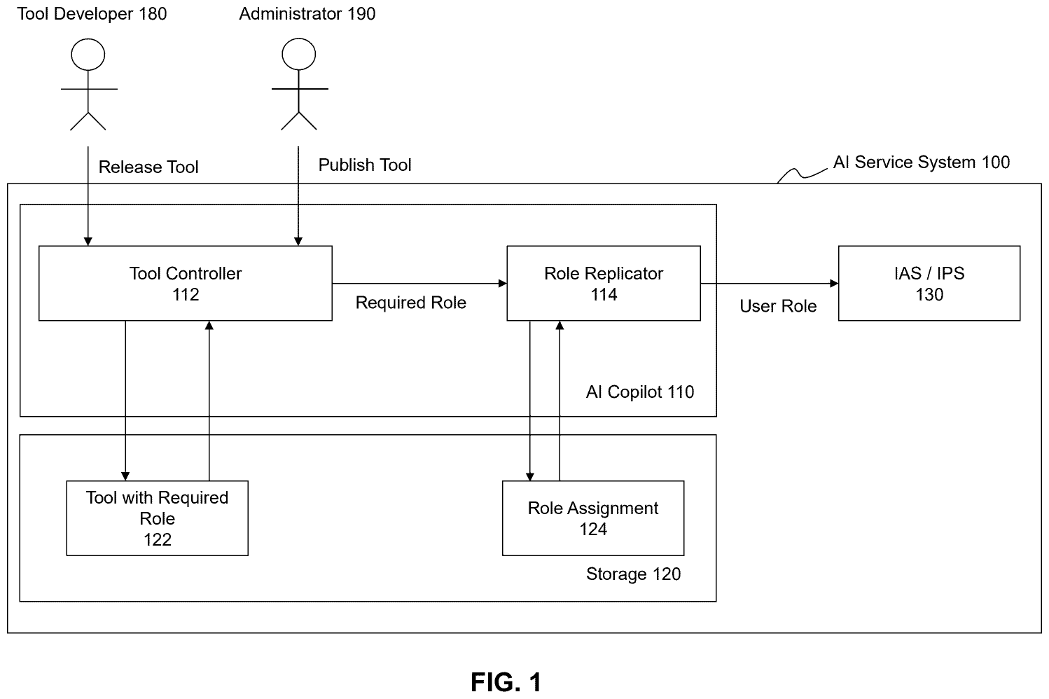

FIG. 1 is a block diagram of an AI service system 100, according to some embodiments. AI service system 100 may include AI copilot 110, storage 120, and identity authentication service (IAS) or identity provisioning system (IPS) 130 (“IAS/IPS 130”).

AI copilot 110 may be a generative AI performing a tool in AI service system 100 for a user through a conversation with the user. AI copilot 110 may include tool controller 112 and role replicator 114.

Tool controller 112 may receive a request from tool developer 180 and administrator 190. Tool developer 180 may develop a tool. The tool may be a function performed in a product running on AI service system. For example, the tool may have a function to fetch details of a sales order, and the products related to sales activities may use this tool, or AI copilot 110 may use this tool in response to a prompt input by the user. Tool developer 180 may transmit a request to release a tool to tool controller 112. Administrator 190 may administrate tools on AI service system 100. Administrator 190 may transmit a request to publish the tool released by tool developer 180.

The tool published by administrator 190 may be stored in storage 120 as tool 122. Tool 122 may have a description which describes detailed settings of tool 122. For example, the description of tool 122 may include the following;
“description: This function fetches details of a sales order
type: function
parameters:
   -name: order_id
   description: Order number
   value_help: order number #scenario
   validation: validate_order_number #function
   optional: false
function:
   name: get_sales_order_details”
   As described above, tool 122 described above may fetch details of a sales order.

Tool developer 180 may release tool 122 with a required role. For example, in addition to the above description, the description of tool 122 may further include the following as a required role:
“permissions:
name: view_sales_order”
In this way, the required role can express that the user whose role has a permission to view a sales order can perform tool 122. The required role can be expressed in a different way. For example, the description of tool 122 may also include the following as a required role:
“role:
name: sales admin”
In this way, the required role can express that the user whose role is the sales admin can perform tool 122. As explained, the required role can be expressed by specifying characteristics (e.g., permissions, roles, etc.) of the user.

Role replicator 114 may transmit a request to IAS/IPS 130 to obtain a list of user groups and a role assigned to the user group as a group assigned role. IAS/IPS 130 may access an identity management system (IMS) that supports users, groups, roles, and permissions of AI service system 100. Role replicator 114 may receive a list of user groups and the group assigned role from the IMS. Role replicator 114 may replicate the received list of user groups and the group assigned role as role assignment 124 in storage 120. As such, AI copilot 110 may identify a user group to which the user having a conversation belongs based on the list of user groups. Further, AI copilot 110 may determine a user role as the group assigned role corresponding to the identified user group. Role replicator 114 may transmit the request to IAS/IPS 130 and update role assignment 124 periodically.

In this way, based on stored tool (with the required role) 122 and the user role, AI copilot 110 can control the execution of tool 122 according to role assignment 124. Details will be explained further below.

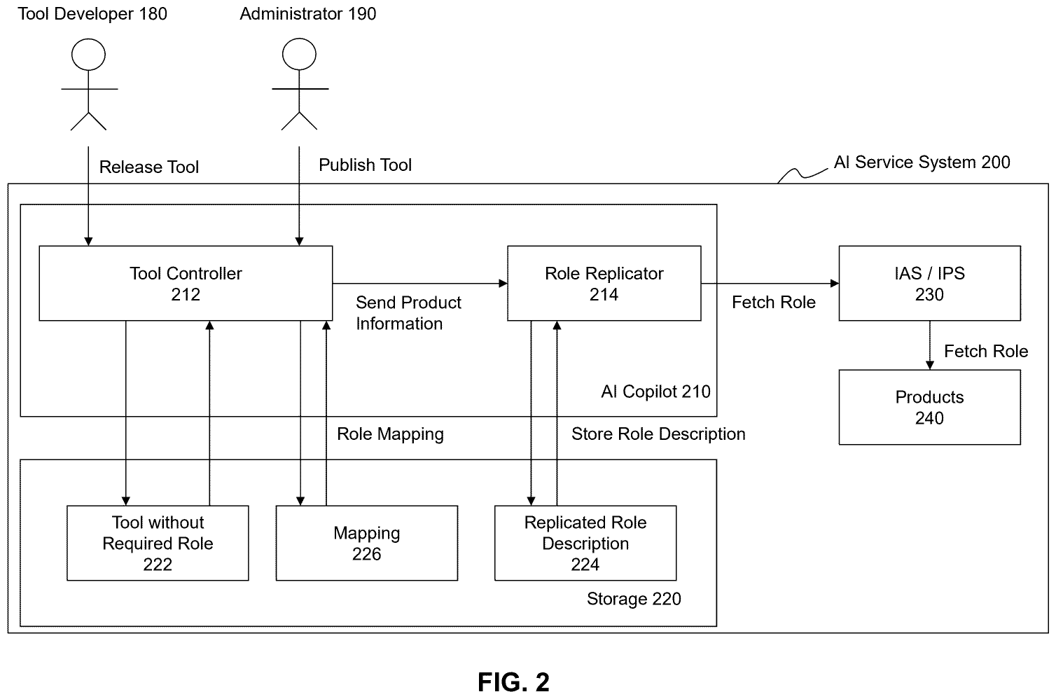

The configuration of the AI service system is not limited to the configuration described above. For example, even if tool developer 180 does not set the required role to tool, the AI service system may be configured so that the AI service system can set the required role. The following FIG. 2 may explain the configuration where the tool is published without a required role.

FIG. 2 is a block diagram of AI service system 200 where tool 222 has a description without a required role, according to some embodiments. Tool controller 212 of AI copilot 210 may store tool 222 in storage 220 without required role. Then, tool controller 212 may send a product information to role replicator 214. The product information may be information of a product, which uses tool 222.

Role replicator 214 may transmit a request to IAS/IPS 230 to fetch a role belonging to the product with a description of the role as a product role. The request to IAS/IPS 230 may be a request to fetch all roles belonging to the product with descriptions of the roles. The description of the role may define characteristics of the role. In response to the request, IAS/IPS 230 may fetch the product role with the description from products 240. In addition, role replicator 214 may determine the user role using role assignment 124 in the manner explained in FIG. 1.

The fetched product role and the description may be replicated and stored in storage 220 as replicated role description 224.

Tool controller 212 may input the description of the tool 222 and replicated role description 224 with a prompt requesting to create a role mapping to a large language model (LLM). The role mapping may include a mapping of the description of tool 222 and replicated role description 224. For example, the large language model may interpret a usage of tool 222 (e.g., fetching a sales order) interpret replicated role description 224 (e.g., a sales manager is responsible for sales) and map tool 222 with replicated role description 224 (e.g., sales manager has a permission to fetch the sales order). The mapping may be stored in storage 220 as mapping 226. The LLM may be executed within the AI service system 200 or outside the AI service system 200.

Further, tool controller 212 may also input, to the LLM, a help document regarding the product with a prompt requesting to create the role mapping based on the help document. The help document may be provided by a system vendor of AI service system 200 to help the users.

In this way, based on the mapping 226, AI copilot 210 can control the execution of tool 222. Details will be explained below.

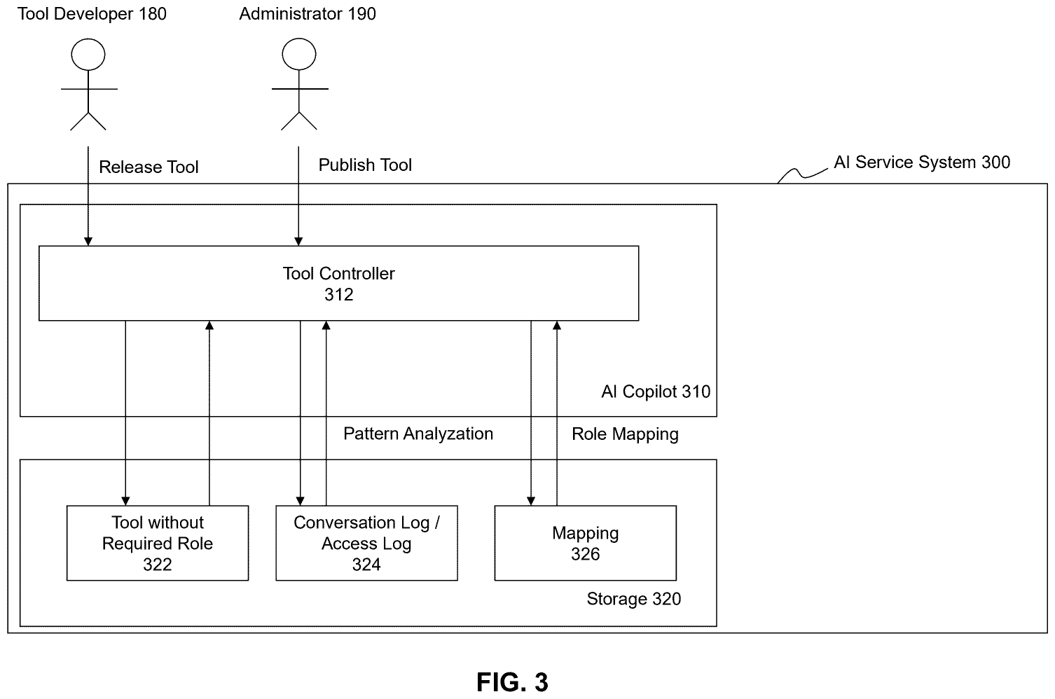

The configuration of the AI service system is not limited to the configurations described above. For example, the AI service system may update the mapping based on an access log or behavior of the user. The following FIG. 3 may explain the configuration where the AI service updates the mapping.

FIG. 3 is a block diagram of an AI service system 300 where the AI service system 300 updates the mapping 326, according to some embodiments. Tool controller of AI copilot 310 may store tool 322 without the required role. The mapping 326 may be created in the same way as explained above using FIG. 2. In addition, AI service system 300 may include role replicator 214, replicated role description 224, IAS/IPS 230, and products 240, in the same way as the system described using FIG. 2.

Tool controller 312 may analyze a pattern of a conversation log stored during a current session. As explained, AI copilot 310 may have a conversation with the user by exchanging inputs and outputs. The conversation log may be stored as conversation log 324 for each session in storage 320. The session may be a period from when a user logs into AI service system 300 to when they log out. For example, if conversation log 324 includes signs that the user in charge of the sales department is complaining about not being able to access the tool, tool controller 312 may update the mapping 326 to allow the sales manager to access tool 322. Tool controller 312 may analyze a pattern of a conversation log stored during a previous session. Tool controller 312 may output a message to tool developer 180 or administrator 190 to update mapping 326 instead of updating mapping 326.

Tool controller 312 may also analyze an access log. The access log may be an access log to AI service system 300 obtained from a behavior of the user. The access log may be stored as access log 324 in storage 320. For example, if the access log shows that a user tried to access a tool or product that is only accessible to senior members of the sales department, tool controller 312 update the mapping 326 to allow the sales manager to access tool 322. Tool controller 312 may output a message to tool developer 180 or administrator 190 to update mapping 326 instead of updating mapping 326.

In this way, based on the updated mapping 326, AI copilot 310 can control the execution of tool 322. Details will be explained further below.

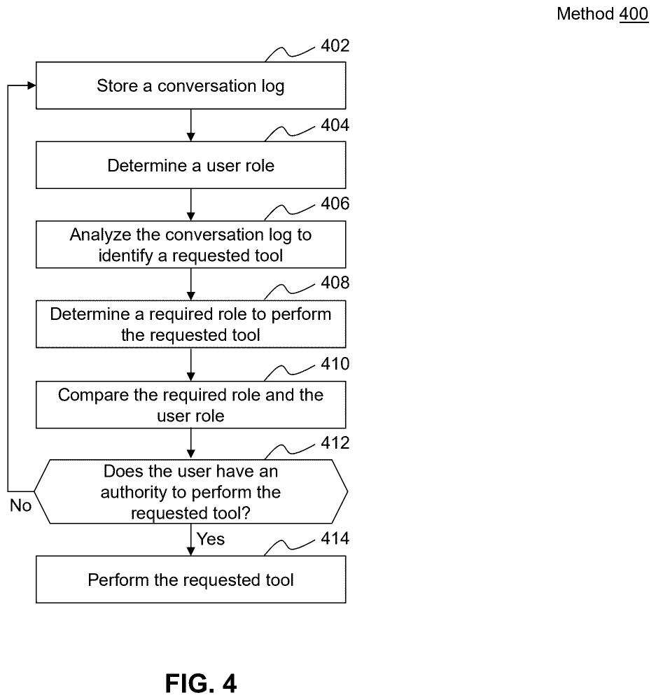

FIG. 4 is a flowchart for a method 400 for performing a tool based on a user role, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-3. However, method 400 is not limited to that example embodiment.

In 402, AI service system 100, 200, or 300 may store a conversation log. AI service system 100, 200, or 300 may support three conversational patterns:
Navigational: Helps users navigate to the functionality they are looking for.
Transactional: Assists users in efficient completion of their tasks.
Informational: Helps users retrieve the information from existing documents.
For example, the input from the user and the output to the user from AI service system 100, 200 or 300 are stored in storage 120, 220, or 320.

In 404, AI service system 100, 200, or 300 may determine the user role. For example, AI service system 100 may determine the user role based on role assignment 124. In another example, AI service system 200 or 300 may determine the user role using role replicator 214.

In 406, AI service system 100, 200, or 300 may analyze the conversation log to identify a requested tool. For example, AI service system 100, 200 or 300 may determine that the user wants to fetch the sales order based on the conversation log. AI service system may 100, 200, or 300 identify the tool based on a retrieval-augmented generation explainability (RAGe) of the AI service system 100, 200, or 300 by comparing embeddings of a descriptions of tool with embeddings of the conversation log.

In 408, AI service system 100, 200, or 300 may determine a required role to perform the requested tool. For example, AI service system 100 may determine the required role from the description of the tool stored within tool with required role 122. In another example, AI service system 200 or 300 may determine the user role based on mapping 226 or 326.

In 410, AI service system 100, 200, or 300 may compare the required role and the user role.

In 412, AI service system 100, 200, or 300 may determine whether the user has an authority to perform the requested tool. For example, if the user role matches or is included in the required role, the AI service system may determine that the user has an authority to perform the requested tool.

In 414, if AI service system 100, 200, or 300 determine that the user has the authority to perform the requested tool, AI service system 100, 200, or 300 may perform the requested tool.

If AI service system 100, 200, or 300 may determine that the user does not have the authority to perform the requested tool, the process may returns to operation 402. AI service system 100, 200, or 300 may also inform to the user that the user is missing the required role to execute the tool.

As such, AI service system 100, 200, or 300 may dynamically compare the user role and the required role. Further, AI service system 100, 200, or 300 may assist effective conversation between AI copilot 110, 210, or 310 and the user for matching the user and the tool by using boundary conditions based on the user roles and required roles. In addition, AI service system 100, 200, or 300 may proactively invoke the tools, which leads to improved user experience.

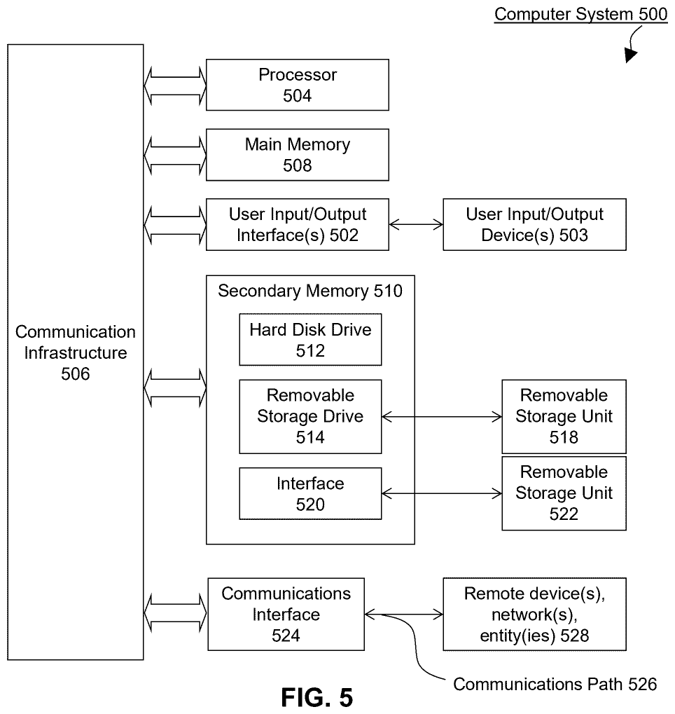

FIG. 5 is an example computer system useful for implementing various embodiments. Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). A GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, /d/ any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for performing a tool based on a user role, comprising:
storing, by at least one processor, a conversation log, wherein the conversation log comprises a user input to an Artificial Intelligence (AI) copilot and an AI output to a user, wherein the AI copilot runs on an AI service system;
determining the user role of the user;
analyzing the conversation log to identify a requested tool requested by the user;
determining a required role required to perform the requested tool;
comparing the required role and the user role;
determining, based on the comparison, that the user has an authority to perform the requested tool; and
performing the requested tool.

2. The computer-implemented method of claim 1, the determining the user role further comprising:
receiving, from an identity management system (IMS), a list of user groups and a group assigned role assigned to the list of user groups; and
identifying a user group to which the user belongs based on the list of user groups; and
determining the user role as the group assigned role corresponding to the identified user group.

3. The computer-implemented method of claim 1, the determining the required role further comprising:
receiving a description of the requested tool;
receiving a description of a product role belonging to a product which uses the requested tool;
inputting, to a large language model (LLM), the description of the requested tool and the description of the product role with a prompt requesting to create a role mapping comprising a mapping of the description of the requested tool and the description of the product role; and
determining the required role based on the role mapping.

4. The computer-implemented method of claim 3, the inputting the description of the requested tool and the description of the product role to the LLM further comprising:
inputting, to the LLM, a help document regarding the product; and wherein the prompt requests the LLM to create the role mapping further based on the help document.

5. The computer-implemented method of claim 3, further comprising:
analyzing the conversation log stored during a current session; and
updating the mapping based on the analyzation.

6. The computer-implemented method of claim 3, further comprising:
analyzing an access log to the AI service system; and
updating the mapping based on the analyzation.

7. The computer-implemented method of claim 3, further comprising:
analyzing the conversation log stored during a previous session occurred before a current session; and
updating the mapping based on the analyzation.

8. A system for performing a tool based on a user role, comprising:
a memory; and
at least one processor coupled to the memory and configured to:
store a conversation log, wherein the conversation log comprises a user input to an Artificial Intelligence (AI) copilot and an AI output to a user, wherein the AI copilot runs on an AI service system;
determine the user role of the user;
analyze the conversation log to identify a requested tool requested by the user;
determine a required role required to perform the requested tool;
compare the required role and the user role;
determine, based on the comparison, that the user has an authority to perform the requested tool; and
perform the requested tool.

9. The system of claim 8, wherein to determine the user role, the at least one processor is configured to:
receive, from an identity management system (IMS), a list of user groups and a group assigned role assigned to the list of user groups; and
identify a user group to which the user belongs based on the list of user groups; and
determine the user role as the group assigned role corresponding to the identified user group.

10. The system of claim 8, wherein to determine the required role, the at least one processor is configured to:
receive a description of the requested tool;
receive a description of a product role belonging to a product which uses the requested tool;
input, to a large language model (LLM), the description of the requested tool and the description of the product role with a prompt requesting to create a role mapping comprising a mapping of the description of the requested tool and the description of the product role; and
determine the required role based on the role mapping.

11. The system of claim 10, wherein to input the description of the requested tool and the description of the product role to the LLM, the at least one processor is configured to:
input, to the LLM, a help document regarding the product; and wherein the prompt requests the LLM to create the role mapping further based on the help document.

12. The system of claim 10, the at least one processor further configured to:
analyze the conversation log stored during a current session; and
update the mapping based on the analyzation.

13. The system of claim 10, the at least one processor further configured to:
analyze an access log to the AI service system; and
update the mapping based on the analyzation.

14. The system of claim 10, the at least one processor further configured to:
analyze the conversation log stored during a previous session occurred before a current session; and
update the mapping based on the analyzation.

15. A non-transitory computer-readable medium having instructions stored thereon that, when executed by at least one computing device, cause the at least one computing device to perform operations comprising:
storing a conversation log, wherein the conversation log comprises a user input to an Artificial Intelligence (AI) copilot and an AI output to a user, wherein the AI copilot runs on an AI service system;
determining a user role of the user;
analyzing the conversation log to identify a requested tool requested by the user;
determining a required role required to perform the requested tool;
comparing the required role and the user role;
determining, based on the comparison, that the user has an authority to perform the requested tool; and
performing the requested tool.

16. The non-transitory computer-readable medium of claim 15, the determining the user role further comprising:
receiving, from an identity management system (IMS), a list of user groups and a group assigned role assigned to the list of user groups; and
identifying a user group to which the user belongs based on the list of user groups; and
determining the user role as the group assigned role corresponding to the identified user group.

17. The non-transitory computer-readable medium of claim 15, the determining the required role further comprising:
receiving a description of the requested tool;
receiving a description of a product role belonging to a product which uses the requested tool;
inputting, to a large language model (LLM), the description of the requested tool and the description of the product role with a prompt requesting to create a role mapping comprising a mapping of the description of the requested tool and the description of the product role; and
determining the required role based on the role mapping.

18. The non-transitory computer-readable medium of claim 17, the inputting the description of the requested tool and the description of the product role to the LLM further comprising:
inputting, to the LLM, a help document regarding the product; and wherein the prompt requests the LLM to create the role mapping further based on the help document.

19. The non-transitory computer-readable medium of claim 17, further comprising:
analyzing the conversation log stored during a current session; and
updating the mapping based on the analyzation.

20. The non-transitory computer-readable medium of claim 17, further comprising:
analyzing an access log to the AI service system; and
updating the mapping based on the analyzation.
